(19) United States
(12) Patent Application Publication
(10) Pub. No.: US 2005/0100477 A1
(43) Pub. Date: May 12, 2005

(54) Apparatus and method for removing gas prior to sample detection and/or analysis

(75) Inventors: James M. Anderson JR., Arlington Heights, IL (US); Raaidah Saari-Nordhaus, Antioch, IL (US); Rakesh Bose, Wheeling, IL (US); Carl W. Sims, Saint Paul, MN (US); Yuri Gerner, Mendota Heights, MN (US)

Correspondence Address: Brinks Hofer Gilson & Lione;NBC Tower, Suite 3600, P.O. Box 10395, Chicago, IL, 60610, US

(73) Assignee: ALLTECH ASSOCIATES, INC.

(21) Appl. No.: 10/702,805

(22) Filed: Nov. 6, 2003

(51) Int. Cl. G01N 30/02

(52) U.S. Cl. 422/70

(57) ABSTRACT

An improved apparatus to remove gases (or a particular gas) from a sample prior to detection of the sample. The apparatus and method is useful in the removal of gas from the mobile phase in a detection and analysis apparatus.

The present invention relates to the field of sample detection and/or analysis by ion chromatography (IC), high-pressure liquid chromatography, ultra-violet detection, refractive index measurement, fluorescence, chemiluminescence, mass spectroscopy, gas chromatography, electrochemical detector, and the like. In particular, the present invention relates to an improved apparatus to remove gases (or a particular gas) prior to detection of a sample, and to a method of using the apparatus.

The detection and analysis of sample ions or materials in a fluid stream is accomplished by many well-known methods. Oftentimes, however, a substance such as a gas or a specific gas like carbon dioxide interferes with the equipment used to detect and analyze the sample ions or materials. In these instances and others, it is desirable to remove all the gas (or a specific gas) from the fluid that contains the sample material to be analyzed. The gas to be removed may be dissolved or absorbed within the mobile phase (the fluid to be analyzed). For example, in some gas chromatography applications, it would be desirable to remove the oxygen from the gas to be analyzed because the oxygen can oxidize the stationary phase.

A solution to the general problem is shown in U.S. Pat. No. 5,340,384, which describes a flow-through vacuum-degassing unit for degassing a liquid. The unit contains semipermeable tubing through which the mobile phase (i.e., the fluid containing the material to be analyzed) flows. At least a portion of the tubing is placed in a vacuum chamber such that the gas that is present within the tubing passes through the tubing and is carried away.

Another solution as implemented with a liquid chromatography system is shown in U.S. Pat. No. 6,444,475. In that patent, the effluent of the suppressor flows to the detector through liquid impermeable gas permeable tubing. Suitable back pressure devices are provided in the system to create sufficient pressure to drive the gas in the suppressor effluent through the tubing before the suppressor effluent enters the detector.

A drawback to each of these proposed solutions is that they rely on the permeability of the tubing and on either (1) the concentration gradient of the gas that exists between the inside of the tubing and the outside of the tubing or (2) the difference in the partial pressure of the gas between the fluid on the inside of the tubing and the fluid on the outside of the tubing. Accordingly, there is room for improvement in the rate and amount of gas that can be removed from the fluid to be analyzed.

The apparatus and method of the present invention addresses this and other problems by providing a scavenger that will augment the removal of gas from a fluid.

### SUMMARY OF THE INVENTION

In general, the present invention provides an improved apparatus and method that enhances the removal of gas in a fluid. More specifically, the present invention relates to an apparatus and method useful in connection with the detection and analysis of materials where the apparatus and method are used to remove a gas from a fluid in such a system. The gas may be dissolved or absorbed in the fluid. The fluid may be a fluid entering the inlet of a sample detection and analysis system, such as a liquid or gas chromatography system. In other words, the fluid may be a mobile phase for a sample detection and analysis system. The fluid may also be a carrier for the fluid containing material to be detected and/or analyzed or it may be a fluid used for sample preparation.

To simplify the following description, but without limiting the scope of the appended claims, the fluid containing a gas to be removed will be referred to as the mobile phase.

In one aspect of the present invention, a chamber having an inlet and an outlet is provided. A mobile phase containing one or more materials to be detected and/or analyzed passes from the inlet into the chamber and out of the chamber through the outlet. The chamber contains a scavenger that is selective to a second material that is in the mobile phase. The scavenger acts to reduce the concentration of the second material as the mobile phase passes through the chamber. In other words, at the inlet of the chamber, the mobile phase contains a first concentration of the second material and, at the outlet of the chamber; the mobile phase contains a second concentration of the second material, such that the second concentration is less than the first concentration. As used in the following specification and appended claims, the term second material is meant to encompass a single material or several materials.

The mobile phase may be a gas or a liquid. In either case, the mobile phase may be physically separated from the scavenger by a barrier such as a tubing, a membrane, or the like. Desirably, when the mobile phase is a gas, the mobile phase is physically separated from the scavenger by a barrier that will allow gas to pass through the barrier yet contain a majority of the gas within the barrier. In addition, where the mobile phase (fluid) is a liquid, the mobile phase may be physically separated from the scavenger by a barrier that will allow the gas to pass through the barrier. The barrier may be tubing, a membrane, or some other substance. Alternatively, the mobile phase (fluid) may be in direct contact with the scavenger while the mobile phase is in the chamber. For example, if the mobile phase is a liquid and the scavenger is a solid, the scavenger may fill all or a portion of the interior of the chamber so that as the mobile phases passes from the inlet to the outlet, the mobile phase is in direct contact with the scavenger.

In one embodiment, the scavenger is selected so that it reacts with the second material to reduce the concentration of the second material present in the mobile phase. In addition, the scavenger can react with the second material to convert the second material to a different state, such as to a liquid or a solid. As a result, the concentration gradient of the second material will be greater between the inlet and the outlet of the chamber or between the barrier that separates the mobile phase from the scavenger. The greater the concentration gradient, the greater the rate and amount of removal of the second material from the mobile phase.

In a particular embodiment, the present invention is useful in a liquid chromatography system where the sample containing fluid (mobile phase) also contains a second material such as a gas. The gas may be, for example, carbon dioxide, which will interfere with the detection and/or analysis of the mobile phase. The gas may be dissolved or absorbed in the liquid. In this embodiment, the mobile phase is flowed to an inlet of a chamber, where the mobile phase is physically separated from the scavenger, and then out the chamber through an outlet. The barrier may be tubing, membrane, or other material. The scavenger is physically separated from the mobile phase but is located within the chamber. As the mobile phase passes from the inlet to the outlet of the chamber, the concentration of the carbon dioxide in the mobile phase is reduced. The scavenger may be a gas, a liquid, or a solid. For example, where the mobile phase is a liquid and the gas is carbon dioxide, the scavenger can be a gas such as ammonia, which will react with the carbon dioxide to increase the concentration gradient between the outlet and the inlet of the chamber. Alternatively, the scavenger could be a liquid such as sodium hydroxide, which will also react with the carbon dioxide to increase the concentration gradient between the outlet and the inlet of the chamber.

In another embodiment, the apparatus and method may be useful to purify further fluids such as those fluids used for the mobile phase of a sample detection and analysis system. For example, the mobile phase used in connection with an anion analysis system should not contain a high concentration of carbonate. Accordingly, the mobile phase can be passed through a stationary cation phase to acidify the mobile phase and can then be passed into the chamber that contains the scavenger to reduce or remove any carbon dioxide in the mobile phase.

### BRIEF DESCRIPTION OF THE DRAWINGS

FIG. 1 is a schematic view of one embodiment of a chamber according to the present invention, where the mobile phase is in direct contact with the scavenger.

FIG. 2 is a schematic view of another embodiment of a chamber according to the present invention where the mobile phase is in a barrier physically separated from the scavenger and where the barrier is in the form of tubing.

FIG. 3 is a schematic of another embodiment of a chamber according to the present invention where the mobile phase is in a barrier physically separated from the scavenger and where the scavenger is in the form of a gas or a liquid that can be stationary or can flow in a generally cross-current direction to the flow of the mobile phase.

FIG. 4 is a schematic of another embodiment of a chamber according to the present invention where the chamber is in the form of tubing that surrounds the barrier, which separates the mobile phase from the scavenger where the scavenger is in the form of a gas or a liquid in the chamber.

FIG. 5 is a schematic of a particular embodiment of a system according to the present invention having a suppressor for use in a method of continuous electrochemically suppressed ion chromatography and having the improved gas removal apparatus of the present invention.

FIG. 6 is a schematic view of a portion of a chromatographic analysis system with one type of suppressor for which the improved gas removal apparatus and method of the present invention may find use.

FIG. 7 is a schematic view of a portion of a chromatographic analysis system with one type of suppressor for which an alternative embodiment of the improved gas removal apparatus and method of the present invention may find use.

### DESCRIPTION OF THE INVENTION

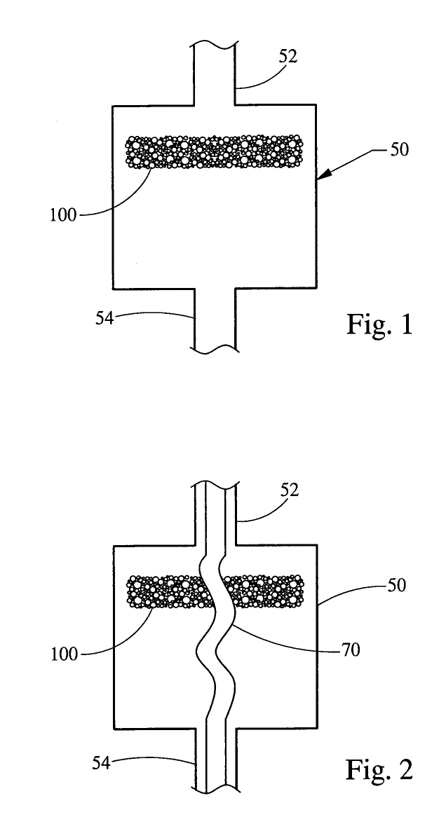

Turning now to FIG. 1, a general schematic of a chamber according to the present invention is illustrated. The chamber 50 is useful in a sample detection and analysis system. The chamber 50 has an inlet 52 and an outlet 54. The inlet 52 receives fluid flow of a mobile phase (a fluid) that contains a gas, to be removed from the mobile phase. As pointed out above, the mobile phase may be a fluid comprising the inlet to a sample detection and analysis system, such as a liquid or gas chromatography system. In other words, the fluid may be a mobile phase for a sample detection and analysis system. The mobile phase may also be a carrier for the fluid containing material to be detected and/or analyzed or it may be a fluid used for sample preparation.

The chamber 50 contains a scavenger 100 that will interact with the gas in the mobile phase to reduce the amount or concentration of the gas in the mobile phase as it passes from the inlet 52 to the outlet 54 of the chamber 50. In general, the scavenger 100 will interact with the gas to be removed from the mobile phase by reacting with it to change its physical state from a gas to a solid or liquid. Alternatively, where the scavenger 100 is a solid, the gas may be bound with or to the scavenger 100 such that the amount of concentration of gas in the mobile phase is reduced. As one skilled in the art will appreciate, in the embodiment shown in FIG. 1, the mobile phase is in direct contact with the scavenger 100.

As an example of the use of the chamber 50 according to FIG. 1, the mobile phase may be a liquid that contains an undesirable gas such as carbon dioxide. The scavenger 100 in this case could be a solid selected from the group consisting of insoluble metal oxides, metal hydroxides, anion exchange resin, organic amines, and organic imines or other insoluble materials that will react with the gas such as carbon dioxide in the mobile phase to convert the gas such as carbon dioxide into a solid or to bind the gas such as carbon dioxide to the scavenger. As used in the specification and claims, the term solid when used with the term scavenger is meant to include solids such as an inert substrate that contains a scavenger 100 that is chemically or physically bound to the inert substrate as well as scavengers 100 that are solid themselves.

Where the gas in the mobile phase is carbon dioxide, the scavenger may be selected from alkali metal hydroxides such as LiOH, NaOH, KOH, RbOH and CsOH; alkaline-earth metal hydroxides such as MgOH, CaOH, SrOH, and BaOH; metal oxides such as, but not limited to sodium, potassium, magnesium, calcium, barium, aluminum, iron, cobalt, nickel, zinc, titanium, and silver oxides; alkali carbonates such as Li₂CO₃, Na₂CO₃, K₂CO₃, Rb₂CO₃, and Cs₂CO₃; amines such as monoethanolamine, methyl diethanolamine, 2-(2-aminoethoxy)ethanol, and 3-amino-1-propanol; NH₄OH, lithium silicate, granular baralyme, anion exchange resin, immidazolium salt, biotin, biotic analogs, homogentisate, salts of homogentisate, and mixtures thereof.

Where the gas in the mobile phase is oxygen, the scavenger may be selected from metal oxides such as copper oxide, zinc oxide, aluminum oxide, calcium oxide, and iron oxide; alkali metal and alkaline earth metal compounds including, but not limited to, carbamates, hydroxides, carbonates, bicarbonates, tertiary phosphates, and secondary phosphates; transition metal salts which include copper, manganese, zinc, iron, nickel, lead, and zinc; phenolic compounds such as catechol and gallic acid; quinone compounds such as benzoquinone and diphenoquinone; D-iso-ascorbic acid and/or salts thereof, salcomine, ethomine, boron or reducing boron compounds, 1,2-glycol, glycerin, sugar alcohol, iron powder, sodium dithionite, any linear hydrocarbon polymer having one or more unsaturated groups, any linear hydrocarbon polymer having one or more unsaturated groups but no carboxylic groups with an oxygen promoter as essential components, or a mixture of a linear hydrocarbon polymer having one or more unsaturated groups with an unsaturated fatty acid compound and an oxidative promoter as essential components and optionally containing a basic substance and/or an adsorption substance, and any mixtures thereof.

Turning now to FIG. 2, an alternative embodiment of the present invention is shown. In this embodiment, the mobile phase is physically separated from scavenger 100 by a barrier 70. As shown in FIG. 2, the barrier 70 is depicted as tubing that passes from the inlet 52 of the chamber 50 to the outlet 54 of the chamber 50. The barrier 70 is formed of a material to allow selective passage of the gas that is to be removed from the mobile phase. In other words, the gas that is to be removed can pass from the side of the barrier 70 that does not contain the scavenger 100 to the side of the barrier 70 that contains the scavenger. It is known that some stationary phases used in gas chromatography systems are sensitive to the presence of oxygen and therefore it is desired to remove as much oxygen as possible before the mobile phase contacts the stationary phase. Accordingly, an oxygen scavenger such as a gas purification catalyst may be placed within the chamber 50. Suitable gas purification catalysts include but are not limited to metal oxides such as copper oxide, zinc oxide, and aluminum oxide. Advantageously, the presence of the scavenger 100 can reduce or entirely eliminate the need for a vacuum pump or similar apparatus, which is typically used in known systems.

Where the mobile phase is a liquid, the barrier can be a gas permeable liquid impermeable material. Where the mobile phase is a gas, the barrier 70 can be a material that allows selective passage of a particular gas in contrast to the other gases. For example, if the gas that is to be removed is oxygen, the barrier 70 will allow the oxygen to pass through the barrier 70 yet retain the other gases. One type of membrane is described in U.S. Pat. No. 5,876,604, the contents of which are incorporated herein by reference. The described membrane is formed from an amorphous copolymer of perfluoro-2,2-dimethyl-1,3-dioxole.

In the embodiment shown in FIG. 2, the scavenger 100 may be present in a carrier such as a gas or a liquid. As a particular example, where the mobile phase contains carbon dioxide, the scavenger 100 may be gaseous ammonia alone, or mixed with a carrier such as air. In addition, the scavenger 100 may be present in the chamber in a static manner or may be flowed through the chamber, such as from the inlet 52 of the chamber to the outlet 54 of the chamber or from the outlet 54 of the chamber to the inlet 52 of the chamber. When it is sought to flow the scavenger 100 through the chamber 50, the flow can be accomplished either by a vacuum or by positive air pressure. Positive air pumps, liquid pumps, and related devices to accomplish either are well known to those skilled in the art.

In any event, the scavenger 100 interacts with the carbon dioxide to reduce the carbon dioxide concentration in the mobile phase from the chamber inlet 52 to the chamber outlet 100. In other words, the carbon dioxide concentration gradient between the outlet of the chamber and the inlet of the chamber is increased as compared to the concentration gradient when no scavenger is present.

As another example where the mobile phase contains carbon dioxide that is to be removed, the scavenger 100 may be a liquid such as sodium hydroxide, which is carried by water. The sodium hydroxide will react with the carbon dioxide to form sodium bicarbonate. The sodium hydroxide may be present in the chamber in a static fashion or may be flowed co-currently or counter-currently to the flow of the mobile phase. The sodium hydroxide can be supplied from a source external to the detection and analysis system or from a source that is a part of the detection and analysis system, as will be explained below in connection with a particular embodiment of the present invention.

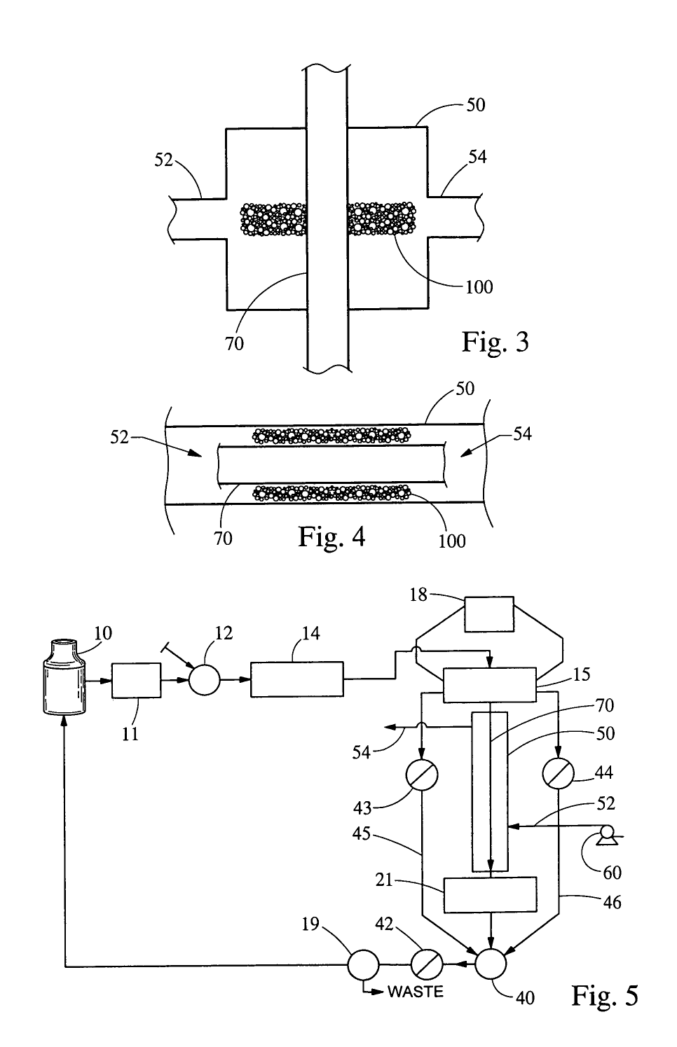

FIG. 3 shows another embodiment of the chamber 50 according to the present invention that is similar to that shown in FIG. 1, except that the flow of the scavenger 100 can be in a direction that is crosscurrent to the flow direction of the mobile phase.

FIG. 4 shows yet another embodiment of the chamber 50, which is in the form of a tubing that also surrounds the barrier 70 to separate the mobile phase from the scavenger 100. The scavenger 100 is in the form of a gas or a liquid that can be stationary or can flow in a co-current or counter-current direction to the flow of the mobile phase.

Referring now to FIG. 5, a particular embodiment of the present invention is shown in connection with a continuous electrochemically suppressed ion chromatography system. The system comprises a mobile phase source 10 that includes an electrolyte, a pump 11, a sample injector 12, and a chromatography column 14, all in fluid communication. The pump 11, sample injector 12, and chromatography column 14 may be selected from the variety of types known by those skilled in the art. For example, suitable pumps include the ALLTECH 526 pump available from ALLTECH ASSOCIATES, INC. (Deerfield, Ill.). Suitable chromatography columns include the ALLTECH ALLSEP or UNIVERSAL CATION COLUMNS. Suitable sample injectors include the RHEODYNE 7725 injection valve.

The suppressor 15 is in fluid communication with the chromatography column 14. The suppressor 15, which contains electrodes (not shown), is discussed in further detail below. The suppressor 15 is connected to a power source 18. An example of a power source is the KENWOOD PR36-1.2A. The system also includes a barrier 70 in liquid communication with the suppressor 15 and a detector 21. The barrier may be in the form of a gas permeable tubing such as TEFLON AF 2400 (DUPONT) tubing available from BIOGENERAL of San Diego, Calif., from SYSTEC, INC. of Minneapolis, Minn., or other suitable gas permeable liquid impermeable tubing. Alternatively, the barrier may be in the form of a membrane or other suitable structure to separate physically the mobile phase from the scavenger. At least a portion of the tubing 70 is located within a chamber 50 that operates to remove some or all of a portion of gas (or a particular gas) present in the barrier 70.

By flowing the mobile phase and sample ions through the barrier 70 before reaching the detector 21, gas may be removed before the mobile phase and sample ions reach the detector 21. As a result, detection of the sample ions is improved. A suitable detector 21 for use in the present invention is the ALLTECH MODEL 550 CONDUCTIVITY DETECTOR. Other suitable detectors for use with the present invention are electrochemical detectors. The detector 21 measures or records the analyte ions detected by the detector.

In operation, the direction of fluid flow is as follows. The mobile phase is flowed from mobile phase source 10 by pump 11 through injection valve 12 to chromatography column 14 to suppressor 15, through barrier 70, and then to detector 21. Upon exiting the detector 21, the mobile phase is flowed through a cross 40 through back pressure regulator 42 and then to recycling valve 19, which directs fluid flow either to waste or back to mobile phase source 10 as discussed below. The recycling valve 19 can be a three-way valve.

According to one aspect of the invention, and with reference to FIG. 5, the mobile phase comprising electrolyte and analyte ions (e.g., sample ions that are to be detected) are flowed to chromatography column 14 where the analyte ions are separated. The separated analyte ions and electrolyte exit the chromatography column 14 as chromatography effluent and flowed to suppressor 15 where the electrolyte is suppressed.

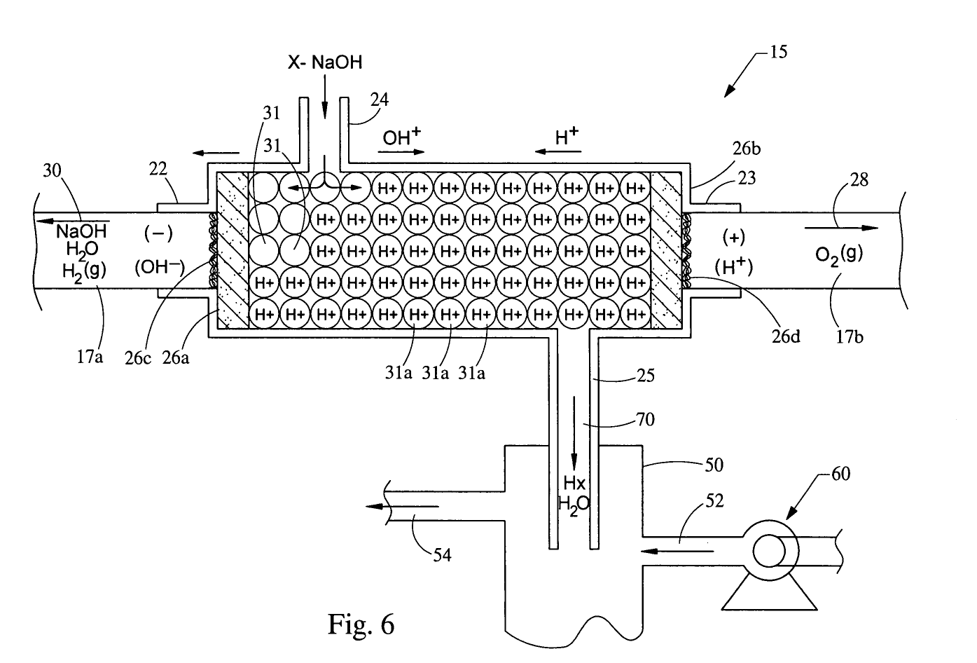

The operation of suppressor 15 is described with reference to FIG. 6 for anion analysis and a mobile phase consisting of an aqueous solution of sodium hydroxide. As those skilled in the art will quickly appreciate, the invention may easily be adapted for cation analysis and/or different electrolytes.

Referring to FIG. 6, the suppressor 15 comprises first stationary phase 31 and second stationary phase 31a. By stationary phase, it is meant chromatography material comprising ion exchange functional groups in either free resin form or in any matrix that permits liquid flow therethrough. The stationary phase is preferably a strong cation exchanger, such as a sulfonic acid cation exchanger exemplified by BIORAD AMINEX 50WX8. The stationary phase may also comprise a solid polymer structure such as monolith that permits liquid flow therethrough. The suppressor may also include end filters, 26a and 26b, comprising strong cation exchange resin encapsulated in a TEFLON filter mesh located at both ends of the suppressor 15. These end filters limit the amount of gas that is generated at the regeneration electrodes during electrolysis from entering the suppressor 15 during electrolysis. Suitable end filters are ALLTECH NOVO-CLEAN IC-H Membranes. The suppressor 15 further comprises a first regeneration electrode 22 and a second regeneration electrode 23. In this embodiment, the first regeneration electrode 22 is the cathode and the second regeneration electrode 23 is the anode. The first and second regeneration electrodes are preferably flow-through electrodes that are connected to a power source 18 (not shown). The preferred electrodes are made of a titanium housing with flow-through titanium frits, 26c and 26d. The electrodes are platinum plated to provide an inert, electrically conductive surface. The suppressor 15 further comprises an inlet 24 for receiving the chromatography column effluent and a first outlet 25 for flowing suppressed chromatography effluent (which contains analyte ions) to the detector 21. The suppressor 15 also comprises second and third outlets 28 and 30, respectively, through regeneration electrodes 23 and 22, respectively.

During a sample run, power is continuously applied to activate regeneration electrodes 22 and 23 while providing water to the suppressor 15. The water source may be the chromatography effluent or a separate water source may be provided. In any event, electrolysis of the water occurs at the regeneration electrodes generating electrolysis ions selected from the group consisting of hydronium ions and hydroxide ions. In the present embodiment, hydronium ions are generated at the anode (second regeneration electrode 23) and hydroxide ions are generated at the cathode (first regeneration electrode 22). The hydronium ions are flowed from the second regeneration electrode 23 across second stationary phase 31a and first stationary phase 31 to first regeneration electrode 22. The hydronium ions eventually combine with the hydroxide ions generated at first regeneration electrode 22 to form water, which may exit the suppressor at third outlet 30.

In operation, the chromatography effluent is introduced into the suppressor 15 at inlet 24. In this embodiment, the chromatography effluent comprises separated anions in an aqueous sodium hydroxide eluant. Upon entering the suppressor at inlet 24, the chromatography effluent is split into two chromatography effluent flow streams; namely a first chromatography effluent flow stream and a second chromatography effluent flow stream. The first chromatography effluent flow stream flows in a first chromatography effluent flow path from the inlet 24 through the first stationary phase 31 positioned between the inlet 24 and the first regeneration electrode 22. Thus, the first chromatography effluent flow path is defined by the flow of the first chromatography effluent flow stream from inlet 24 to first regeneration electrode 22. The first chromatography effluent flow stream may exit the suppressor 15 through the first regeneration electrode 22 and third outlet 30. The second chromatography effluent flow stream flows in a second chromatography effluent flow path from the inlet 24 through second stationary phase 31 a, which is positioned between the inlet 24 and the second regeneration electrode 23, to the second regeneration electrode 23. Preferably, a portion of the second chromatography effluent exits the suppressor 15 at first outlet 25 and another portion at second outlet 28 through second electrode 23. The second chromatography effluent stream exiting at first outlet 25 is flowed to the detector where the analyte ions are detected.

In the suppressor 15, the sodium ion electrolyte in the chromatography effluent preferably migrates from the second chromatography effluent flow stream into the first chromatography effluent flow stream by the combined action of the hydronium ion flow from the second regeneration electrode 23 to the first regeneration electrode 22 and the negative charge at the first regeneration electrode 22. The second chromatography effluent flow stream thus comprises separated anions that combine with the hydronium electrolysis ions to create the highly conductive acids of the analyte anions. The second chromatography effluent flow stream further comprises water that is generated, at least in part, by the hydroxide ions from the sodium hydroxide eluant combining with the hydronium electrolysis ions.

A portion of the second chromatography effluent flow stream exits the suppressor 15 at second and first outlets 28 and 25, respectively. The suppressed second chromatography effluent comprises an aqueous solution of the separated analyte anions in their acid form along with oxygen gas generated at the second regeneration electrode from the hydrolysis of water. Because the oxygen gas may interfere to some extent with the detection of the analyte anions at the detector, the suppressed second chromatography effluent exiting first outlet 25 is desirably flowed through a chamber 50 where the oxygen gas is removed prior to detecting the analyte ions. Desirably, the effluent is provided within a barrier 70, which is schematically shown as a tubing, a portion of which is located within the chamber 50.

A back pressure source 42 (see FIG. 5) may also be included in the system to create back pressure to enhance the transfer of gas through the barrier 70 and out of first suppressor effluent. Similarly, back pressure sources 43 and 44 are likewise provided (see FIG. 5) to provide further pressure control in the system. As can be ascertained from FIG. 6, increasing the backpressure in the suppressed second chromatography effluent stream exiting at outlet 25 could disturb fluid flow through the suppressor 15. Therefore, it is preferable to apply counterbalancing pressure in the second chromatography effluent stream exiting at second outlet 28 and first chromatography effluent stream exiting at third outlet 30. The suppressed second chromatography effluent flow stream exiting suppressor 15 at first outlet 25 is then flowed through the chamber 50 within the barrier 70 to the detector 21 where the analyte ions are detected.

Because power is applied while analyte ions are flowed through the suppressor 15, that is, because the regeneration electrodes are continuously activated and an electrical potential is continuously applied across the first stationary phase 31 and second stationary phase 31 a, there is a continuous flow of hydronium ions from the second regeneration electrode 23 to the first regeneration electrode 22. It is believed that this continuous flow of hydronium ions allows the second stationary phase 31a in the second chromatography effluent flow path to remain continuously in its substantially unexhausted form. Thus, in the present embodiment, a hydronium form ion exchange resin will remain substantially in its unexhausted or hydronium form in the second chromatography effluent flow stream because sodium ions are substantially precluded from entering the second chromatography effluent flow stream (and thus they are unavailable to exhaust the second stationary phase 31a) and are driven into the first chromatography effluent flow stream. Additionally, although the first stationary phase 31 in the first chromatography effluent flow path may become at least partially exhausted by ion exchange of the sodium ions with hydronium ions, a continuous supply of hydronium ions is available to regenerate continuously the first stationary phase 31 by ion exchange with retained sodium ions.

The first chromatography effluent flow stream will exit the suppressor 15 at third outlet 30 as a third suppressor effluent and will comprise hydroxides of the sample countercations and an aqueous sodium hydroxide solution which is formed from the hydroxide ions generated at the first regeneration electrode 22 combining with, respectively, the sodium ion electrolyte and the hydronium electrolysis ions generated at the second regeneration electrode 23. The third suppressor effluent flow stream further comprises hydrogen gas generated by the electrolysis of water at the first regeneration electrode 22. The third suppressor effluent 30, in this embodiment, may contain a portion of the analyte anions. By removing the hydrogen gas through known methods in the art (as, for example, by gas permeable tubing) and removing the analyte anions by known methods, the aqueous sodium hydroxide solution may be reused by flowing it back to the eluant source 10 and using it as the mobile phase in a subsequent sample run. Alternatively, the third suppressor effluent flow stream 30 may be flowed to waste. In yet another alternative, the third suppressor effluent flow stream 30 may be flowed to the inlet of the chamber 50, as will become apparent when discussed below.

As those skilled in the art will recognize, the suppressor 15 discussed above may be used in methods for continuous electrochemically suppressed ion chromatography for both anion and cation analysis. Moreover, various eluants may be used such as hydrochloric acid or methanesulfonic acid for cation analysis and sodium carbonate/bicarbonate, sodium hydroxide, or sodium phenolate for anion analysis. The first stationary phase 31 and the second stationary phase 31 a may be different or the same. Alternatively, within the first or second chromatography effluent flow paths the stationary phase may be the same or a combination of free ion exchange resin, ion exchange resin encapsulated in a membrane matrix, or a solid polymer structure. The stationary phase, however, must permit fluid flow therethrough and the ion flow as discussed above. Examples of suitable stationary phases for anion analysis include DOWEX 50WX8 and JORDIGEL SO₃. Examples of suitable stationary phases for cation analysis include AMINEX AG-X8 and ZIRCHROM RHINO PHASE SAX.

As discussed previously, the hydrogen gas and oxygen gas by-products from the electrolysis of water are desirably removed prior to detection of the sample ions at the detectors. In accordance with the present invention, the mobile phase passes through the chamber 50, which contains a scavenger. The mobile phase may be physically separated from the scavenger by a barrier 70, a portion of which is located within the chamber 50.

The apparatus of the present invention may find particular use during suppression of carbonate/bicarbonate mobile phases. When a carbonate/bicarbonate mobile phase is used, dissolved carbonic acid is produced. The dissolved carbonic acid is relatively conductive, as compared to water, and thus creates a “background noise” that interferes with detection of the sample ions. Moreover, in gradient elution ion chromatography using carbonate/bicarbonate mobile phases, the background signal caused by the dissolved carbonic acid in the suppressed mobile phase fluctuates causing baseline drift that makes sample ion detection very difficult. In addition, when using carbonate/bicarbonate mobile phases, a water dip is seen at the beginning of the chromatograph because the water carrying sample ions has a lower conductivity than the suppressed carbonate/bicarbonate mobile phase. This water dip interferes with the detection of early eluting peaks such as fluoride. The problems associated with carbonate/bicarbonate mobile phases may be substantially reduced or eliminated by removing carbon dioxide gas from the suppressed sodium carbonate/bicarbonate mobile phase prior to detecting the sample ions.

The dissolved carbonic acid from the suppression of the carbonate/bicarbonate mobile phase exists according to the following equilibrium:
H⁺+HCO₃⁻H₂O+CO₂ (g)
This equilibrium favors carbonic acid (HCO₃⁻). By removing the carbon dioxide gas, the equilibrium moves to the right to aid in removing dissolved carbonic acid. It has been discovered that by removing sufficient amounts of carbon dioxide gas, the levels of dissolved carbonic acid may be reduced to substantially eliminate the problems described above.

As noted above, the present invention provides an improved method and apparatus for removing and for enhancing the removal of the gases, including carbon dioxide. In general therefore, according to the present invention, the mobile phase is flowed into a chamber 50 where the gas within the mobile phase can interact with a scavenger 100 located within the chamber 50. The scavenger 100 is effective to reduce the amount of carbon dioxide present within the mobile phase. For convenience in such a detection and analysis system, the mobile phase may be contained within a barrier 70 such as gas permeable tubing.

The chamber 50 may be any suitable device that will permit the scavenger 100 to be contained. If, for example, the scavenger is a liquid or gas, the chamber should be constructed to contain the scavenger 100 and to permit either a negative or a positive pressure within the chamber. The chamber 50 has an inlet 52, typically provided at one end of the chamber 50 and an outlet 54, typically provided at another end opposite the inlet 52. The inlet 52 may be fluidically connected to a pump 60, which is capable of moving the scavenger 100 or fluid containing the scavenger 100 through the chamber 50.

The chamber 50 desirably surrounds a substantial portion of the length of the barrier 70 to provide effective reduction of the gas within the barrier 70 from the chamber inlet 52 to the chamber outlet 54. One skilled in the art will understand that providing a chamber 50 to provide effective reduction of gas in the mobile phase will offer benefits, even for suppressed ion chromatography (“SIC”) systems not using carbonate/bicarbonate mobile phase.

The chamber 50 includes and/or contains a scavenger 100, as described above. The scavenger 100 may be provided in a carrier fluid selected from a gas or a liquid. When the carrier fluid is a gas, the chamber 50 may be pressurized (either a positive pressure or a negative pressure) or not. The scavenger 100 or its carrier, if used, may be provided in the chamber 50 so that the scavenger 100 or its carrier is static, i.e., not moving. In this instance, pumps and air movers can be dispensed with, which will reduce the complexity and cost of the system. Alternatively, the scavenger 100 or its carrier within the chamber 50 may be such that the scavenger 100 or its carrier fluid flows past the barrier 70. Accordingly, the flow of the scavenger 100 or its carrier fluid within the chamber 50 can be in a direction that is co-current, counter-current, or cross-current with respect to the flow of the mobile phase.

As noted above, the scavenger 100 within the chamber 50 may be a liquid or may be carried by a liquid carrier. The scavenger 100 or its carrier may be static or it may flow past the barrier 70 in a direction co-currently, counter-currently, or cross-currently with respect to the flow direction of the mobile phase within the barrier 70. In general, since the operation of a chromatography apparatus typically uses water, the carrier may desirably include water or a liquid compatible with water.

Scavengers effective for reducing or removing carbon dioxide from the mobile phase may be selected from alkali metal hydroxides such as LiOH, NaOH, KOH, RbOH and CsOH; alkaline-earth metal hydroxides such as MgOH, CaOH, SrOH, and BaOH; metal oxides such as, but not limited to sodium, potassium, magnesium, calcium, barium, aluminum, iron, cobalt, nickel, zinc, titanium, and silver oxides; alkali carbonates such as Li₂CO₃, Na₂CO₃, K₂CO₃, Rb₂CO₃, and Cs₂CO₃; amines such as monoethanolamine, methyl diethanolamine, 2-(2-aminoethoxy)ethanol, and 3-amino-1-propanol; NH₄OH, lithium silicate, granular baralyme, immidazolium salt, biotin, biotic analogs, homogentisate, salts of homogentisate, and mixtures thereof. One skilled in the art will understand that each of the above scavengers will react with the carbon dioxide in the fluid within the barrier and will therefore shift the carbonic acid equilibrium to reduce the amount of carbonic acid present in the mobile phase.

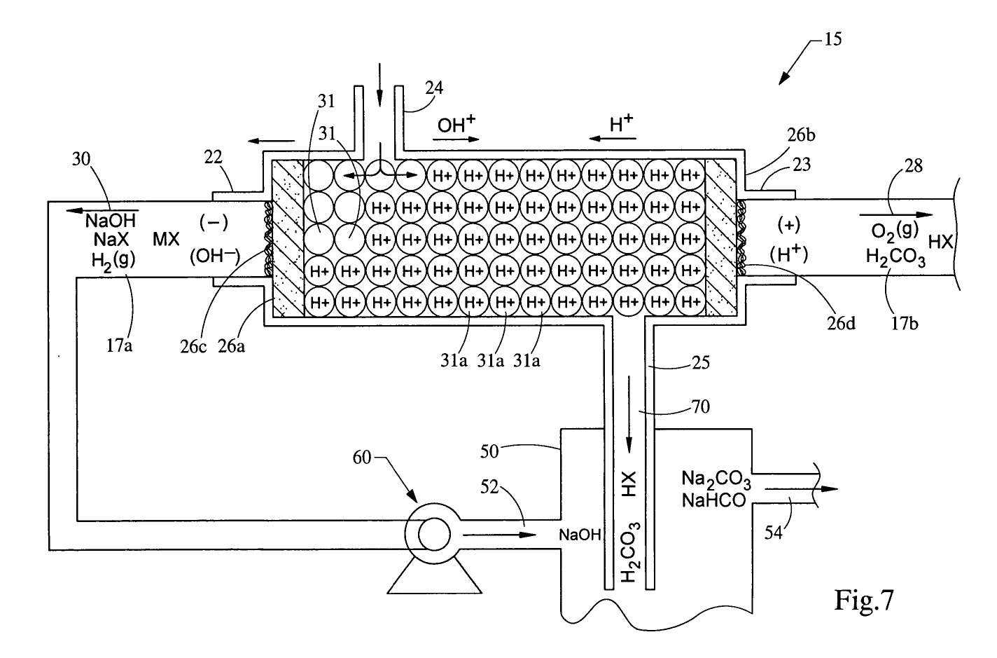

FIG. 7 is a schematic of a portion of a chromatography apparatus and in particular a portion showing a suppressor 15 that is operating with a sodium carbonate and/or sodium bicarbonate mobile phase. The chamber 50 contains a carrier fluid that includes NaOH as a scavenger 100. In this embodiment, the NaOH is generated as part of the cathode waste stream that flows out of outlet 30. The NaOH can then be flowed into the enclosure 50 through inlet 52. Although FIG. 7 shows a pump, it is to be understood that a pump is not necessary. As the liquid flows through the enclosure 50, the NaOH will react with the CO₂ from the mobile phase to form Na₂CO₃ and NaHCO₃. Because of the decreasing concentration of the CO₂ in the mobile phase stream, the carbonic acid equilibrium will shift and the concentration of carbonic acid will correspondingly decrease (the concentration gradient will increase). As a result, there is an improved detection of analytes and a reduction in the background noise to interfere with the detection of samples. Alternatively, the NaOH may be provided from a source external to the chromatography apparatus.

One skilled in the art will understand that the above method of removing carbonic acid is applicable to all methods of suppressed ion chromatography using an aqueous carbonate/bicarbonate mobile phase.

It will be understood by one skilled in the art that the back pressure regulator 42 may be eliminated when the chamber is provided. Alternatively, the back pressure regulator 42 may be used and, when it is used, it is believed that, in combination with the chamber 50, the gas present in the mobile phase will be more effectively removed.

While the invention has been described in conjunction with specific embodiments, it is to be understood that many alternatives, modifications, and variations will be apparent to those skilled in the art in light of the foregoing description. Accordingly, this invention is intended to embrace all such alternatives, modifications, and variations that fall within the spirit and scope of the appended claims.

1. A sample detection system comprising:
a. an aqueous mobile phase containing a gas;
b. a chamber having an inlet and an outlet, wherein the inlet receives at least a portion of the mobile phase;
c. a scavenger located in the chamber effective to reduce the concentration of gas within the mobile phase as the mobile phase moves from the inlet to the outlet; and,
d. a detector.

2. The sample detection system of claim 1 wherein the system is selected from the group consisting of ion chromatography, liquid chromatography, ultra-violet detection, refractive index measurement, fluorescence, chemiluminescence, and mass spectroscopy.

3. The sample detection system of claim 1 wherein the outlet of the chamber is fluidically connected to an inlet of the detector.

4. The sample detection system of claim 1 wherein the gas is selected from oxygen, carbon dioxide, carbon monoxide, nitrogen, hydrogen, formic acid, and trifluoroacetic acid.

5. The sample detection system of claim 1 wherein the gas is carbon dioxide.

6. The sample detection system of claim 5 wherein the scavenger is selected from LiOH, NaOH, KOH, RbOH and CsOH; MgOH, CaOH, SrOH, and BaOH; sodium, potassium, magnesium, calcium, barium, aluminum, iron, cobalt, nickel, zinc, titanium, and silver oxides; Li₂CO₃, Na₂CO₃, K₂CO₃, Rb₂CO₃, and Cs₂CO₃; monoethanolamine, methyl diethanolamine, 2-(2-aminoethoxy)ethanol, and 3-amino-1-propanol; NH₄OH, lithium silicate, anion exchange resin, granular baralyme, immidazolium salt, biotin, biotic analogs, homogentisate, salts of homogentisate, and mixtures thereof.

7. The sample detection system of claim 1 wherein the scavenger is selected from the group consisting of a liquid or a solid.

8. The sample detection system of claim 1 wherein the mobile phase is in physical contact with the scavenger.

9. The sample detection system of claim 1 wherein the mobile phase is physically separated from the scavenger.

10. The sample detection system of claim 9 wherein the mobile phase is physically separated from the scavenger by a barrier.

11. The sample detection system of claim 10 wherein the barrier is selected from the group consisting of a tubing, a membrane, or an immiscible liquid.

12. The sample detection system of claim 10 wherein the gas is oxygen.

13. The sample detection system of claim 12 wherein the scavenger is selected from the group consisting of copper oxide, zinc oxide, aluminum oxide, calcium oxide, iron oxide; carbamates, hydroxides, carbonates, bicarbonates, tertiary phosphates, secondary phosphates; salts of copper, manganese, zinc, iron, nickel, lead, and zinc; catechol and gallic acid; benzoquinone and diphenoquinone; D-iso-ascorbic acid and salts thereof, salcomine, ethomine, boron, reducing boron compounds, 1,2-glycol, glycerin, sugar alcohol, iron powder, sodium dithionite, linear hydrocarbon polymers having one or more unsaturated groups, linear hydrocarbon polymers having one or more unsaturated groups but no carboxylic groups with an oxygen promoter as essential components, a mixture of a linear hydrocarbon polymer having one or more unsaturated groups with an unsaturated fatty acid compound and an oxidative promoter as essential components and optionally containing a basic substance or an adsorption substance, and any mixtures thereof.

14. The sample detection system of claim 1 wherein the scavenger is static relative to the mobile phase.

15. The sample detection system of claim 1 wherein the scavenger flows in a direction relative to the mobile phase that is selected from the group consisting of co-currently, counter-currently, and cross-currently.

16. The sample detection system of claim 10 wherein the chamber is a tubing that surrounds the barrier.

17. A sample detection system comprising:
a. a mobile phase containing a gas;
b. a chamber having an inlet and an outlet, wherein the inlet receives at least a portion of the mobile phase;
c. a scavenger located in the chamber effective to reduce the concentration of gas within the mobile phase as the mobile phase moves from the inlet to the outlet, wherein the scavenger is physically separated from the mobile phase; and,
d. a detector.

18. The sample detection system of claim 17 wherein the mobile phase is a gas.

19. The sample detection system of claim 17 wherein the mobile phase is a liquid.

20. The sample detection system of claim 17 wherein the system is selected from the group consisting of ion chromatography, liquid chromatography, ultra-violet detection, refractive index measurement, fluorescence, chemiluminescence, mass spectroscopy, and gas chromatography.

21. The sample detection system of claim 17 wherein the outlet of the chamber is fluidically connected to an inlet of the detector.

22. The sample detection system of claim 17 wherein the gas is selected from oxygen, carbon dioxide, carbon monoxide, nitrogen, hydrogen, formic acid, and trifluoroacetic acid.

23. The sample detection system of claim 17 wherein the gas is carbon dioxide.

24. The sample detection system of claim 23 wherein the scavenger is selected from LiOH, NaOH, KOH, RbOH and CsOH; MgOH, CaOH, SrOH, and BaOH; sodium, potassium, magnesium, calcium, barium, aluminum, iron, cobalt, nickel, zinc, titanium, and silver oxides; Li₂CO₃, Na₂CO₃, K₂CO₃, Rb₂CO₃, and Cs₂CO₃; monoethanolamine, methyl diethanolamine, 2-(2-aminoethoxy)ethanol, and 3-amino-1-propanol; NH₄OH, lithium silicate, anion exchange resin, granular baralyme, immidazolium salt, biotin, biotic analogs, homogentisate, salts of homogentisate, and mixtures thereof.

25. The sample detection system of claim 17 wherein the scavenger is selected from the group consisting of a liquid or a solid.

26. The sample detection system of claim 17 wherein the mobile phase is physically separated from the scavenger by a barrier.

27. The sample detection system of claim 26 wherein the barrier is selected from the group consisting of a tubing, a membrane, or an immiscible liquid.

28. The sample detection system of claim 26 wherein the gas is oxygen.

29. The sample detection system of claim 28 wherein the scavenger is selected from the group consisting of copper oxide, zinc oxide, aluminum oxide, calcium oxide, iron oxide; carbamates, hydroxides, carbonates, bicarbonates, tertiary phosphates, secondary phosphates; salts of copper, manganese, zinc, iron, nickel, lead, and zinc; catechol and gallic acid; benzoquinone and diphenoquinone; D-iso-ascorbic acid and salts thereof, salcomine, ethomine, boron, reducing boron compounds, 1,2-glycol, glycerin, sugar alcohol, iron powder, sodium dithionite, linear hydrocarbon polymers having one or more unsaturated groups, linear hydrocarbon polymers having one or more unsaturated groups but no carboxylic groups with an oxygen promoter as essential components, a mixture of a linear hydrocarbon polymer having one or more unsaturated groups with an unsaturated fatty acid compound and an oxidative promoter as essential components and optionally containing a basic substance or an adsorption substance, and any mixtures thereof.

30. The sample detection system of claim 17 wherein the scavenger is static relative to the mobile phase.

31. The sample detection system of claim 17 wherein the scavenger flows in a direction relative to the mobile phase that is selected from the group consisting of co-currently, counter-currently, and cross-currently.

32. The sample detection system of claim 26 wherein the chamber is a tubing that surrounds the barrier.

33. A liquid chromatographic apparatus comprising:
a. a chromatographic column having an inlet and an outlet;
b. a chamber having an inlet and an outlet, wherein the inlet receives at least a portion of a mobile phase, which contains a gas;
c. a scavenger located in the chamber and effective to reduce the concentration of gas within the mobile phase as the mobile phase moves from the inlet to the outlet.
